(19) United States
(12) Patent Application Publication
(10) Pub. No.: US 2008/0175119 A1
(43) Pub. Date: Jul. 24, 2008

(54) FRONT MONITOR APPARATUS, AND OPTICAL PICKUP APPARATUS AND INFORMATION RECORDING AND REPRODUCING APPARATUS PROVIDED WITH THE SAME

(75) Inventor: Mototsugu FUKUNAGA, Higashihiroshima-Shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 12/013,970

(22) Filed: Jan. 14, 2008

(30) Foreign Application Priority Data
Jan. 19, 2007 (JP) 2007-010750

(51) Int. Cl. G11B 5/55

(52) U.S. Cl. 369/53.27

(57) ABSTRACT

The front monitor apparatus which monitors a laser beam emitted from a semiconductor laser element provided in the optical pickup apparatus includes first and second photodiodes each having different light receiving sensitivity, for receiving the laser beam and outputting a current corresponding to a light receiving intensity, and a current-voltage conversion circuit for differentiating voltage conversion levels for converting a current to a voltage, in association with the respective light receiving elements so that a voltage to be converted when a predetermined current is supplied from a second photodiode having low light receiving sensitivity exceeds a voltage to be converted when the predetermined current is supplied from a first photodiode having high light receiving sensitivity, and outputting a voltage which is obtained by conversion of a current from the respective light receiving elements.

### CROSS-REFERENCE TO RELATED APPLICATION

This application claims priority to Japanese Patent Application No. 2007-010750, which was filed on Jan. 19, 2007, the contents of which are incorporated herein by reference in its entirety.

### BACKGROUND OF THE INVENTION

1. Field of the Invention

The present invention relates to a front monitor apparatus that monitors an intensity of a laser beam emitted from a light emitting element of an optical pickup apparatus for executing recording, reproducing or erasing on an optical recording medium, and the optical pickup apparatus and an information recording and reproducing apparatus which are provided with the same.

2. Description of the Related Art

An optical pickup apparatus forms a minute beam spot on an optical recording medium such as a CD and a DVD by a light beam from a light emitting element so as to execute recording, reproducing or erasing of information.

By emitting a laser beam from the light emitting element in the optical pickup apparatus, when a signal on the optical recording medium is read, when the signal is recorded on the optical recording medium, and when the signal recorded on the optical recording medium is erased, an intensity of the laser beam emitted from the light emitting element needs to be held constant to perform these processes stably. Accordingly, an output of the laser beam from the light emitting element needs to be controlled while monitoring the intensity of the laser beam emitted from the light emitting element. Thus, the optical pickup apparatus is provided with, near the light emitting element, a photodetector called a front monitor apparatus for monitoring an output of the laser beam emitted from the light emitting element. The output of the laser beam emitted from the light emitting element is controlled so as to have a stable intensity by an APC (Auto Power Control) circuit using the output of the laser beam detected by the front monitor apparatus, and thereby the intensity of the laser beam emitted from the light emitting element is set properly in response to recording and reproducing, or erasing on the optical recording medium.

FIG. 7 is a schematic view illustrating a configuration of a conventional optical pickup apparatus.

An optical pickup apparatus 51 comprises a semiconductor laser element 52, a collimation lens 53, a beam splitter 54, an objective lens 55, and a front monitor apparatus 56. The semiconductor laser element 52 emits a laser beam. The collimation lens 53 converts the beam emitted from the semiconductor laser element 52 into a collimated beam. The beam splitter 54 reflects a part of the beam emitted from the semiconductor laser element 52 to guide to the front monitor apparatus 56, and transmits the rest of the beam to guide to the objective lens 55. The objective lens 55 condenses the beam on an optical recording medium 57. The objective lens 55 transmits an outward beam emitted from the semiconductor laser element 52 through a cover layer of the optical recording medium 57 to focus on an information recording surface, and then forms a light spot thereon. The front monitor apparatus 56 is provided with a photodiode PD3 as a light receiving element and a current-voltage conversion circuit 61, and receives the beam emitted from the semiconductor laser element 52 and executes a photoelectric conversion of the received beam.

For example, in the case of an optical path for recording information on the optical recording medium 57, the laser beam emitted from the semiconductor laser element 52 enters the collimation lens 53. The laser beam having entered the collimation lens 53 is converted into a collimated beam, and the collimated beam is transmitted through the beam splitter 54 and converged to the objective lens 55, and then the beam focuses on the information recording surface and is recorded thereon.

Further, as described above, the part of the beam emitted from the semiconductor laser element 52 is reflected by the beam splitter 54 and received by the front monitor apparatus 56, and then an output of the laser beam at the time of recording on the optical recording medium 57 is determined by a light receiving intensity.

In the front monitor apparatus 56, the photodiode PD3 is disposed at a position where the laser beam reflected by the beam splitter 54 can be received. When the laser beam reflected by the beam splitter 54 enters the photodiode PD3, a photoelectric current flows through the photodiode PD3. The photoelectric current flows through the current-voltage conversion circuit 61, and thereby converted into an electrical signal as a detection output. The electrical signal is transmitted to a semiconductor laser element driving apparatus 62 provided with a microcomputer, an APC circuit, and a laser driver. The semiconductor laser element driving apparatus 62 determines the output of the laser beam emitted from the light emitting element based on the electrical signal and transmits a semiconductor laser element controlling signal so that the output of the laser beam emitted from the light emitting element has a constant intensity, to control the semiconductor laser element 52. Thereby, a laser beam of a proper intensity is focused on the optical recording medium 57.

However, in the conventional optical pickup apparatus, variation of accuracy in transmittance and reflectance of the beam splitter causes variation in the detection output of the light receiving element in the front monitor apparatus for each optical pickup apparatus, and the APC circuit connected to the front monitor apparatus needs to be designed in view of this point.

Then, in a related art, a detection output adjusting section provided with a variable resistor for generating the detection output to be supplied to the APC circuit, is disposed in the front monitor apparatus, and thereby it is possible to make the detection output of the front monitor apparatus that has varied for each optical pickup apparatus almost constant, and it is also possible to omit a gain adjustment in the APC circuit (refer to, for example, Japanese Unexamined Patent Publication JP-A 3-147534 (1991)).

However, in the related art, one light receiving element is used to monitor the intensity of the semiconductor laser element at the time of both recording and reproduction of the optical recording medium, and one light receiving element needs to monitor wide range of intensities including at the time of recording and erasure on the optical recording medium, in which the intensity emitted from the semiconductor laser element is high, and at the time of reproduction in which the intensity emitted from the semiconductor laser element is low. In addition, the output of the electrical signal outputted from the front monitor apparatus is also changed significantly between at the time of recording and at the time of reproduction on the optical recording medium.

Further, the semiconductor laser element emits a laser beam of higher output at the time of recording on the optical recording medium than at the time of reproduction on the optical recording medium, and therefore when outputting a waveform called write strategy that is an irradiating condition of an optical pulse for forming a recording mark in the optical recording medium properly, and that is information of emission pattern and emission timing of the semiconductor laser element at the time of recording, the intensity and emission time of the semiconductor laser element needs to be finely controlled.

In the case where information is recorded on a write-once type optical recording medium such as a DVD-R (Digital Versatile Disk Recordable) and a CD-R (Compact Disc Recordable), and a rewritable optical recording medium such as a DVD-RW (Digital Versatile Disk Rewritable) and a CD-R (Compact Disk Rewritable), the semiconductor laser element is driven with a recording pulse having a time width corresponding to the information to be recorded, and thereby the laser beam is irradiated to a recording surface of the optical recording medium to form a recording mark, and then the information is recorded on the optical recording medium. In this case, when a distortion of the recording medium is generated due to heat accumulation, a jitter that is a change in a time axis of a PLL (Phase Looked Loop) clock occurs, resulting that an error rate that is a frequency of an error occurring during the reproduction on the optical recording medium is deteriorated.

In the case of recording on the optical recording medium, in order to suppress the deflection of the recording mark, heat accumulation in a rear end part of the recording mark is suppressed using the write strategy technique described above so that the deflection of the recording mark is solved.

FIGS. 8A and 8B are views illustrating a crown-shaped waveform write strategy and an example of the recording mark formed on the optical recording medium by the write strategy.

FIG. 8A is a view illustrating recording data. A bit cycle for one bit of the recording data is defined as T.

FIG. 8B is a view illustrating an example of the recording mark formed on the optical recording medium by a crown-shaped waveform write strategy. A vertical axis of a graph shows a pulse intensity and a horizontal axis shows a time. As shown in FIG. 8B, the recording mark is written such that a laser beam of higher intensity is applied to the optical recording medium at the beginning of writing, so as to prevent the recording mark at the beginning of writing from becoming narrow. Next, the intensity applied to the optical recording medium is decreased so that the recording mark does not become wide, and the intensity is increased at the end of writing so that accuracy of an edge of the recording mark is improved, then a write pulse is stopped.

The front monitor apparatus is required to have a high speed response in order to monitor the strategy control accurately. The high speed response refers to that no delay is incurred for rising and falling of an output signal when a rectangular wave is inputted as an input signal. When a conversion efficiency from a current to a voltage in the front monitor apparatus is set to be high, a frequency band of the front monitor apparatus becomes narrow, resulting in causing longer rising time and insufficient high speed response.

Further, when the conversion efficiency from a current to a voltage in the front monitor apparatus is set to be high, a ringing may frequently occur in the output signal of the front monitor apparatus by a hyper-response that reacts greatly to an oscillation of a signal and external influences.

FIGS. 9A and 9B are views illustrating a signal waveform to be recorded on the optical recording medium and a waveform of a conversion voltage outputted from the front monitor apparatus. FIG. 9A is a view illustrating a signal waveform to be recorded on the optical recording medium. A recording of a crown-shaped waveform system is carried out on the optical recording medium, and as shown in FIG. 9A, no ringing occurs in an output waveform of the laser beam. However, a ringing occurs in the waveform of the conversion voltage, shown in FIG. 9B, outputted from the front monitor apparatus. When the ringing occurs, it is impossible to monitor stably the laser beam emitted from the semiconductor laser element. The laser beam emitted from the semiconductor laser element is, for example, controlled by the semiconductor laser element driving apparatus 62. Since the semiconductor laser element driving apparatus 62 performs the control based on an electrical signal to be transmitted, even if the intensity of the semiconductor laser element is constant, the semiconductor laser transmitted driving apparatus 62 determines that the intensity is changed and executes the control when the ringing occurs in the electrical signal, resulting that it is impossible to set accurately the output of the laser beam from the semiconductor laser element at the time of recording and reproduction. Specifically, unstable intensity of the semiconductor laser element causes deterioration in recording characteristics of the optical recording medium. In addition, in the case of the reproduction of the optical recording medium with lower output, when a ringing occurs, then the intensity of the semiconductor laser element at the time of reproduction is lowered than is required, and the lack of the intensity causes deterioration of the reproduction characteristics. Moreover, due to the lack of the intensity, it is impossible to detect whether or not a beam spot formed on the recording surface of the optical recording medium follows an information track accurately, that is, it is impossible to detect a tracking error signal accurately, and thereby a tracking servo is deviated from the information track, resulting that it might be impossible to perform a reproduction.

Causes of occurring a ringing include that the conversion efficiency from a current to a voltage in the front monitor apparatus is set to be high as described above, and that, due to a deficiency in a power supply line, a current flows and an output becomes unstable, resulting that the ringing occurs. In the case where the ringing occurs because of the deficiency of the power supply line, it is possible to improve by changing a capacity of a capacitor, or making a power supply pattern or an earth pattern wider, however, in the case the ringing occurs because the conversion efficiency from a current to a voltage in the front monitor apparatus is set to be high, it has been impossible to sufficiently reduce the ringing.

### SUMMARY OF THE INVENTION

An object of the invention is to provide a front monitor apparatus that suppresses ringing which arises in a waveform of a conversion voltage outputted therefrom and enhances recording performance and reproduction performance for an optical recording medium, and to provide an optical pickup apparatus and an information recording and reproducing apparatus which are provided with the same.

The invention provides a front monitor apparatus that monitors a laser beam emitted from a light emitting element provided in an optical pickup apparatus, the front monitor apparatus comprising:

a plurality of light receiving elements each having different light receiving sensitivity, for receiving the laser beam and outputting a current corresponding to a light receiving intensity;

a signal processing circuit for differentiating voltage conversion levels for converting a current to a voltage, in association with the respective light receiving elements so that a voltage to be converted when a predetermined current is supplied from a light receiving element having low light receiving sensitivity exceeds a voltage to be converted when the predetermined current is supplied from a light receiving element having high light receiving sensitivity, and outputting a voltage which is obtained by conversion of a current from the respective light receiving elements.

According to the invention, a front monitor apparatus which monitors a laser beam emitted from a light emitting element provided in an optical pickup apparatus, comprises a plurality of light receiving elements each having different light receiving sensitivity, for receiving the laser beam and outputting a current corresponding to a light receiving intensity, and a signal processing circuit for differentiating voltage conversion levels for converting a current to a voltage, in association with the respective light receiving elements so that a voltage to be converted when a predetermined current is supplied from a light receiving element having low light receiving sensitivity exceeds a voltage to be converted when the predetermined current is supplied from a light receiving element having high light receiving sensitivity, and outputting a voltage which is obtained by conversion of a current from the respective light receiving elements. Accordingly, in the front monitor apparatus, it is possible to convert into the voltages properly in accordance with the currents outputted from each light receiving element, and it is also possible to use the front monitor apparatus under control of a gain of the front monitor apparatus. In the invention, the gain is a value represented by Vb/Va where a voltage outputted when a unit current is inputted to one of current-voltage conversion circuits is a reference voltage (Va), and a voltage outputted when the unit current is inputted to the other current-voltage conversion circuit is Vb, which satisfies a relation Va<Vb.

Accordingly, it is possible to use the front monitor apparatus under control of the gain thereof, and therefore an occurrence of the ringing in the waveform of the conversion voltage outputted from the front monitor apparatus can be suppressed and the laser beam emitted from the semiconductor laser element can be stably monitored. In addition, a frequency band of the front monitor apparatus does not become narrow, and good follow-up performance may be obtained even when an output of the semiconductor laser element changes significantly, with the result that the high speed response may be enhanced.

Further, in the invention, it is preferable that the plurality of light receiving elements and the signal processing circuit are formed into one chip by a semiconductor integrated circuit.

According to the invention, the plurality of light receiving elements and the signal processing circuit are formed into one chip by the semiconductor integrated circuit, and therefore the front monitor apparatus will be inexpensive as compared with an front monitor apparatus formed by attaching a chip of a light emitting element and that of a signal processing circuit. Furthermore, by integrating the plurality of light emitting elements and the signal processing circuit into a same chip, variations in electrical characteristics such as sensitivity of the light receiving element and an output current (DC) are reduced.

Further, the invention provides an optical pickup apparatus comprising the front monitor apparatus described above.

According to the invention, an optical pickup apparatus comprises the front monitor apparatuses described above, and thereby it is possible to improve the high speed response and it is also possible to stably monitor the laser beam emitted from the semiconductor laser element. Furthermore, the optical pickup apparatus is inexpensive as compared with an optical pickup apparatus provided with a front monitor apparatus formed by attaching a chip of a light emitting element and that of a signal processing circuit. In addition, by integrating the plurality of light emitting elements and the signal processing circuit into a same chip, variation in the electrical characteristics such as sensitivity of the light receiving element and an output current (DC) is reduced.

Further, in the invention it is preferable that the optical pickup apparatus comprises a driving section for driving the light emitting elements so that an emission intensity of the laser beam to be emitted is a predetermined one based on the voltage supplied from the signal processing circuit,

the plurality of light receiving elements are the two light receiving elements, and

in the driving section, a light of a higher intensity than the predetermined emission intensity of the light emitting element is detected based on a voltage outputted by supplying a current outputted from one of the light receiving elements to the signal processing circuit, and a light of a lower intensity than the predetermined emission intensity of the light emitting element is detected based on a voltage outputted by supplying a current outputted from the other light receiving element to the signal processing circuit.

According to the invention, the optical pickup apparatus comprises a driving section for driving the light emitting elements so that an emission intensity of the laser beam to be emitted is a predetermined one based on the voltage supplied from the signal processing circuit, the plurality of light receiving elements are the two light receiving elements, and in the driving means a light of a higher intensity than the predetermined emission intensity of the light emitting element is detected based on the voltage outputted by supplying a current outputted from one of the light receiving elements to the signal processing circuit, and a light of a lower intensity than the predetermined emission intensity of the light emitting element is detected based on the voltage outputted by supplying a current outputted from the other light receiving element to the signal processing circuit. Accordingly, it is possible to detect accurately the two electrical signals outputted from the front monitor apparatus based on a high-output laser beam and a low-output laser beam emitted from the semiconductor laser element. Furthermore, the driving section determines the output of the laser beam emitted from the light emitting element based on the detected electrical signals, and drives the light emitting element so that the output of the laser beam emitted from the light emitting element has a constant intensity, and therefore it is possible to condense a laser beam of an appropriate intensity on an optical recording medium.

Further, the invention provides an information recording and reproducing apparatus comprising the optical pickup apparatus described above.

According to the invention, an information recording and reproducing apparatus comprises the optical pickup apparatus described above, and therefore it is possible to use by controlling a gain of the front monitor apparatus and the high speed response is enhanced, and it is also possible to suppress an occurrence of the ringing in the waveform of the conversion voltage outputted from the front monitor apparatus and to monitor stably the laser beam emitted from the semiconductor laser element. Furthermore, based on a high-output laser beam and a low-output laser beam emitted from the semiconductor laser element, it is possible to detect accurately the two signals outputted from the front monitor apparatus. Moreover, the driving section determines the output of the laser beam emitted from the light emitting element based on the detected electrical signals to drive the light emitting element so that the output of the laser beam emitted from the light emitting element has a constant intensity, and therefore it is possible to condense a laser beam of an appropriate intensity on the optical recording medium, with the result that recording performance and reproducing performance for the optical recording medium may be enhanced.

### BRIEF DESCRIPTION OF THE DRAWINGS

Other and further objects, features, and advantages of the invention will be more explicit from the following detailed description taken with reference to the drawings.

FIG. 1 is a schematic view illustrating a configuration of an optical pickup apparatus according to one embodiment of the invention;

FIG. 2 is a schematic view illustrating a configuration of a semiconductor laser element driving apparatus;

FIG. 3 is a graph illustrating an intensity of a laser beam emitted from a semiconductor laser element at the time of recording on an optical recording medium;

FIGS. 4A and 4B are views illustrating waveforms of conversion voltages emitted from a front monitor apparatus;

FIG. 5 is a view illustrating a write strategy of a train-shaped waveform and an example of a recording mark formed on an optical recording medium by the write strategy;

FIG. 6 is a view schematically illustrating a structure of an information recording and reproducing apparatus provided with an optical pickup apparatus according to the invention;

FIG. 7 is a schematic view illustrating a configuration of a conventional optical pickup apparatus;

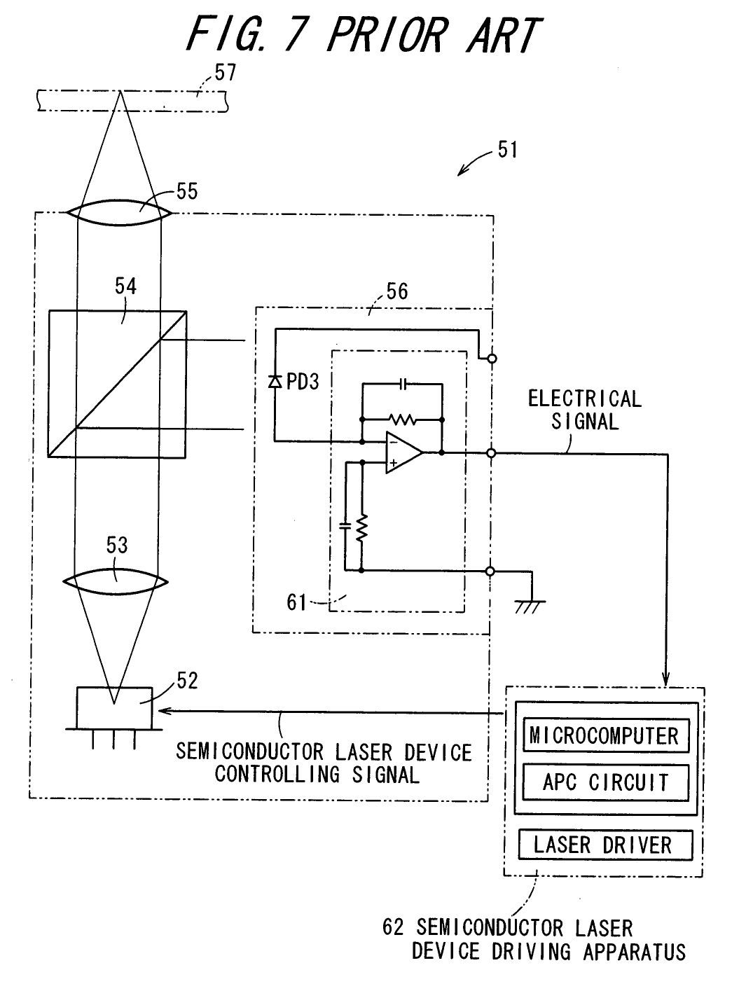

FIGS. 8A and 8B are views illustrating a write strategy of a crown-shaped waveform and an example of a recording mark formed on an optical recording medium by the write strategy; and

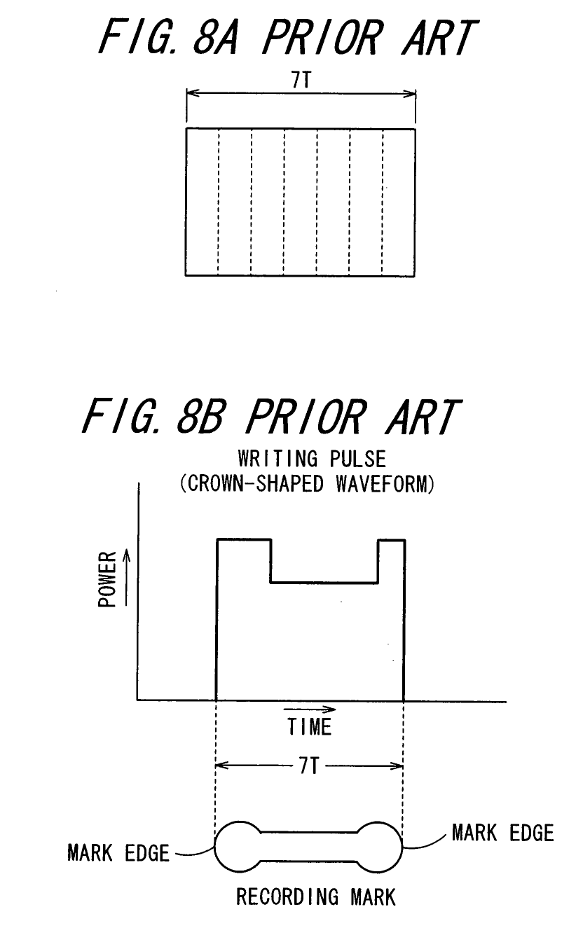

FIGS. 9A and 9B are views illustrating a signal waveform to be recorded on an optical recording medium and a waveform of a conversion voltage outputted from a front monitor apparatus.

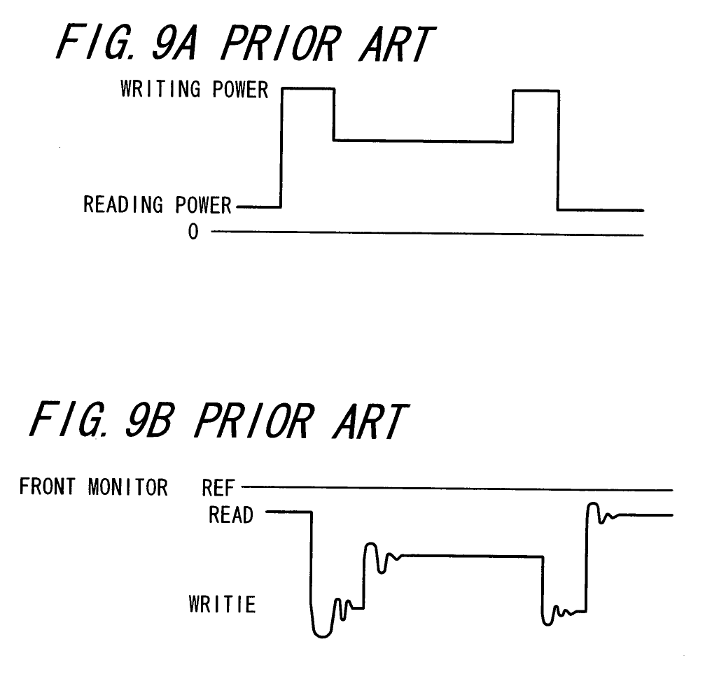

### DETAILED DESCRIPTION

Now referring to the drawings, preferred embodiments of the invention are described below.

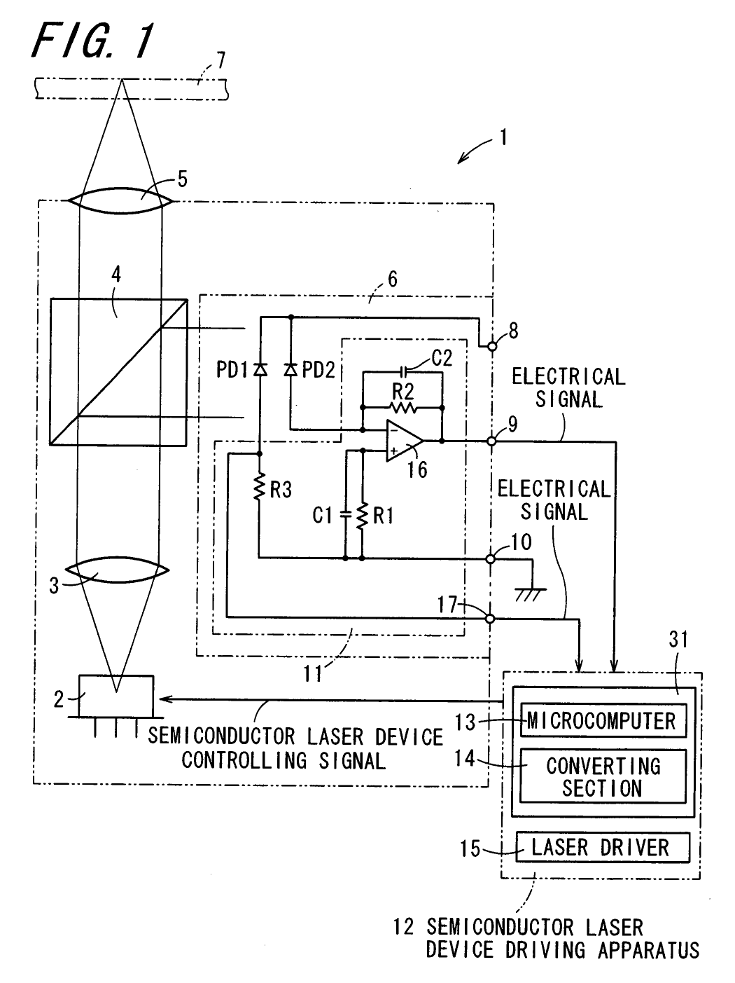

FIG. 1 is a schematic view illustrating a configuration of an optical pickup apparatus 1 according to one embodiment of the invention.

The optical pickup apparatus 1 comprises a semiconductor laser element 2 as a light emitting element, a collimation lens 3, a beam splitter 4, an objective lens 5, a front monitor apparatus 6, and a semiconductor laser element driving apparatus 12 as a light emitting element driving mechanism. The semiconductor laser element 2 emits a laser beam. The collimation lens 3 converts the beam emitted from the semiconductor laser element 2 into a collimated beam. The beam splitter 4 reflects a part of the beam emitted form the semiconductor laser element 2 to guide to the front monitor apparatus 6, and transmits the rest of the beam to guide to the objective lens 5. The objective lens 5 condenses the beam on an optical recording medium 7. The objective lens 5 transmits an outward beam emitted from the semiconductor laser element 2 through a cover layer of the optical recording medium 7 to focus on an information recording surface, and then forms a light spot thereon.

The front monitor apparatus 6 is configured so as to include a first photodiode PD1 and a second photodiode PD2 as light receiving elements, and a current-voltage conversion circuit 11 as a signal processing circuit. The first photodiode PD1 and the second photodiode PD2, and the current-voltage conversion circuit 11 are formed into one chip by a semiconductor integrated circuit. Thus, the optical pickup apparatus is inexpensive as compared with an optical pickup apparatus provided with a front monitor apparatus formed by attaching a chip of a light emitting element and that of a signal processing circuit. Furthermore, by integrating the plurality of light emitting elements and the signal processing circuit into a same chip, variation in the electrical characteristics is reduced. The electrical characteristics include sensitivity of a light receiving element, an output current (DC), an offset, a gain or the like. The first photodiode PD1 and the second photodiode PD2 receive the beam emitted from the semiconductor laser element 2. The current-voltage conversion circuit 11 performs a photoelectric conversion of the received beam.

For example, in the case of an optical path for recording information on the optical recording medium 7, a laser beam emitted from the semiconductor laser element 2 enters the collimation lens 3. The laser beam having entered the collimation lens 3 is converted into a collimated beam and the collimated beam is transmitted through the beam splitter and converged to the objective lens 55, and then the beam reaches to the information recording surface of the optical recording medium 7 and is recorded thereon.

Further, as described above, the part of the beam emitted from the semiconductor laser element 2 is reflected by the beam splitter 4 and received by the front monitor apparatus 6, and then an output of the laser at the time of recording on the optical recording medium 7 is determined by a light receiving intensity.

In the front monitor apparatus 6, the second photodiode PD2 has a cathode connected to a connecting terminal 8, and an anode connected to an inverting input of an operation amplifier 16. In the operational amplifier 16, a non-inverting input is grounded via a first resistance R1 and a first capacitor C1 which is disposed in parallel to the first resistance R1, as well as a second resistance R2 and a second capacitor C2 are connected in parallel between the inverting input and an output of the operational amplifier 16. The first photodiode PD1 is connected to a third resistance R3 in series. One end of the third resistance R3 is grounded, and the other end of the third resistance R3 is connected to the first photodiode PD1 and a connecting terminal 17. In the embodiment, the first resistance R1 is 10 KΩ. The first resistance R1 sets a virtual ground and has no effects on a gain. The second resistance R2 is 1.8 KΩ. The second resistance R2 sets a gain of the operational amplifier 16 and is 1.8 KΩ. The third resistance R3 is 2.2 kΩ. The third resistance R3 controls a current flowing through the first photodiode PD1 and has no effects on a gain. The first capacitor C1 is a capacitor for noise removing and has 0.1 pF of capacity. The second capacitor C2 is a capacitor for preventing an oscillation and has 10 pF of capacity.

Further, the output of the operational amplifier 16 is connected to a connecting terminal 9. The first photodiode PD1 and the second photodiode PD2 are disposed at positions where the laser beam reflected by the beam splitter 4 can be received. When the laser beam reflected by the beam splitter 4 enters the first photodiode PD1 and the second photodiode PD2, photoelectric currents flow through the first photodiode PD1 and the second photodiode PD2. The photoelectric currents flow through the current-voltage conversion circuit 11, and thereby converted into electrical signals as detection outputs. The electrical signal based on the photoelectric current of the second photodiode PD2 is transmitted through the connecting terminal 9, and the electrical signal based on the photoelectric current of the first photodiode PD1 is transmitted through the connecting terminal 17, to a semiconductor laser element driving apparatus 12.

The semiconductor laser element driving apparatus 12 comprises an APC circuit 31, and a laser driver 15, and controls the output of the semiconductor laser element 2.

The APC circuit 31 comprises a microcomputer 13 and a converting section 14, and controls the laser driver 15 based on a conversion voltage signal transmitted from the front monitor apparatus 6.

The laser driver 15 transmits a control signal for setting the output of the semiconductor laser element 2 to the semiconductor laser element 2 under the control of the microcomputer 13, and controls the output of the semiconductor laser element 2 so that the laser beam to be emitted has a predetermined emission intensity. As a result, the laser of appropriate intensity is focused on the optical recording medium 7.

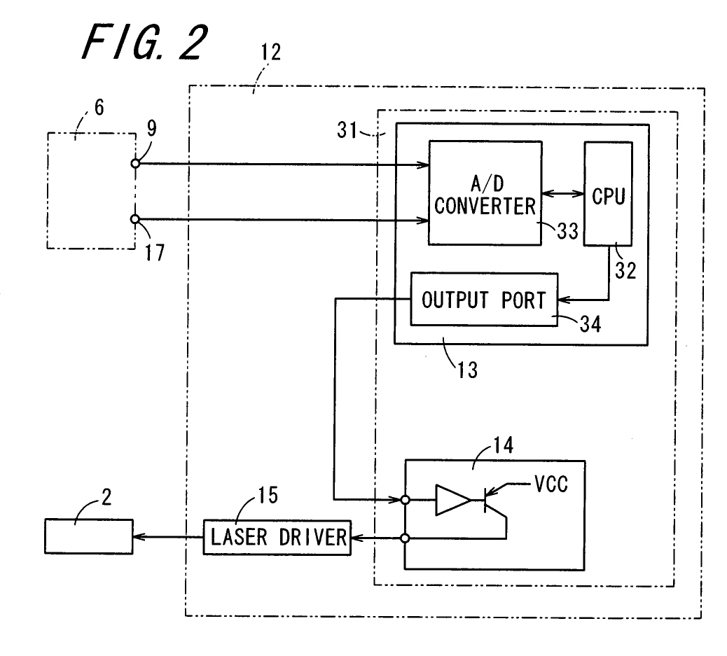

FIG. 2 is a schematic view illustrating a configuration of the semiconductor laser element driving apparatus 12.

The microcomputer 13 of the APC circuit 31 includes a CPU (Central Processing Unit) 32, an A/D (Analog/Digital) converter 33, and an output port 34. In the microcomputer 13, the conversion voltage signal thus transmitted is calculated by the CPU 32, and the output port 34 is controlled based on the result. That is, a high-level signal and a low-level signal are outputted alternately and supplied to the converting section 14. The converting section 14 for converting a voltage to a current controls a current to be flown through the laser driver 15 in response to each signal to be supplied.

The voltage supplied from the front monitor apparatus 6 is inputted to the A/D (Analog/Digital) converter 33 of the microcomputer 13 in the APC circuit 31. Under the control of the microcomputer 13, the APC circuit 31 transmits a control signal to the laser driver 15, and the laser driver 15 drives the semiconductor laser element 2 so that the laser beam to be emitted has a predetermined emission intensity.

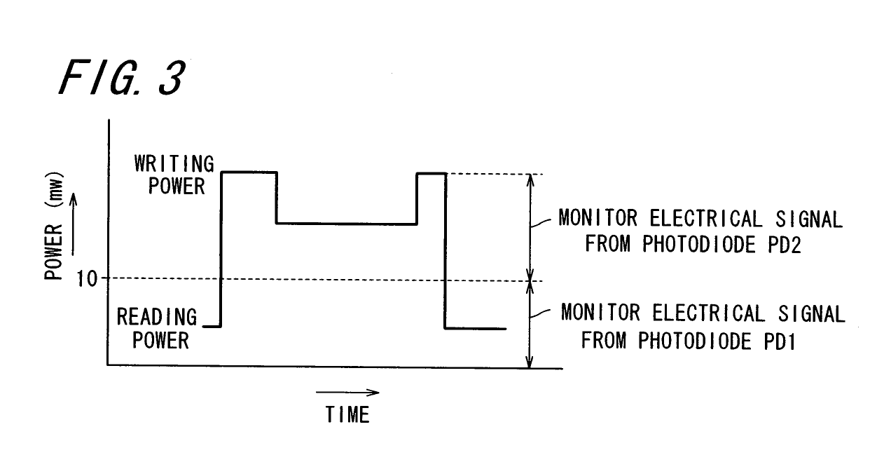

FIG. 3 is a graph illustrating an intensity of the laser beam emitted from the semiconductor laser element 2 at the time of recording on the optical recording medium 7. A vertical axis of the graph shows a pulse intensity and a horizontal axis shows a time. A waveform of the voltage outputted from the front monitor apparatus 6 also shows a same form.

The microcomputer 13 detects a beam of a higher intensity than predetermined emission intensity of the laser beam, based on the voltage converted by the front monitor apparatus 6 from the current outputted by the second photodiode PD2. The predetermined emission intensity is capable of being set arbitrarily at the microcomputer 13. In the embodiment, the predetermined emission intensity is set at 10 mW at the time of recording on the optical recording medium 7. The electrical signals that have been converted to voltages respectively from the laser beam received by the first photodiode PD1 and the second photodiode PD2, are inputted to an A/D conversion port of the APC circuit 31. In addition, when the emission intensity is less than 10 mW, the intensity of the laser beam emitted from the semiconductor laser element 2 is detected based on the voltage that has been converted from the current outputted from the first photodiode PD1 by the front monitor apparatus 6. Specifically, the APC circuit 31, with respect to the voltages converted from the currents outputted from the second photodiode PD2 and the first photodiode PD1 selected on the basis of 10 mW described above, totals numerical values obtained by the A/D conversion to determine the output of the laser beam emitted from the semiconductor laser element 2.

With respect to light receiving characteristics of the first photodiode PD1 and the second photodiode PD2, a photodiode that has high sensitivity so that a laser beam of a low-level light receiving intensity is capable of being sensed is used for the first photodiode PD1, and a photodiode that has low sensitivity is used for the second photodiode PD2.

In the embodiment, the current-voltage conversion circuit 11 differentiates voltage conversion levels for converting a current to a voltage, in association with the respective photodiodes so that a voltage to be converted when a predetermined current is supplied from the second photodiode PD2 exceeds a voltage to be converted when the predetermined current is supplied from the first photodiode PD1, and converts currents from each light receiving element to voltages to output. Accordingly, it is possible to convert to the voltage properly in response to currents outputted from each light receiving element. The predetermined current refers to a current in a range capable of being converted at the current-voltage conversion circuit 11. In the embodiment, since a level fluctuation of the voltage to be converted is small with respect to a current that the emission intensity of the laser beam is in a low-output, a gain may be increased to convert a current that the emission intensity of the laser beam obtained by receiving a light by the photodiode having low sensitivity is in a high-output.

For example, functions may be used selectively such that writing power is monitored only by the second photodiode PD2 and reading power is monitored only by the first photodiode PD1.

Referring to FIG. 1, the APC circuit 31 determines the output of the laser beam emitted from the semiconductor laser element 2, and then transmits the semiconductor laser element controlling signal from the laser driver 15 to the semiconductor laser element 2 and performs such a control that the intensity of the output of the laser beam emitted from the semiconductor laser element 2 is constant. As a result, the intensity of the laser beam emitted from the semiconductor laser element 2 is set properly in accordance with recording, reproduction or erasure on the optical recording medium 7.

Conventionally, when the laser beam emitted from the semiconductor laser element 2 was received by one photodiode, the laser beam was converted to a voltage at a same current-voltage conversion efficiency from a laser beam of a high emission intensity to a laser beam of a low emission intensity, and therefore a ringing has occurred when the emission intensity of the laser beam was high, however, the current-voltage conversion circuit 11 of the front monitor apparatus 6 according to the embodiment converts optical currents of the first photodiode PD1 and the second photodiode PD2 into voltages at different current-voltage conversion efficiencies respectively, resulting that occurrence of the ringing may be suppressed.

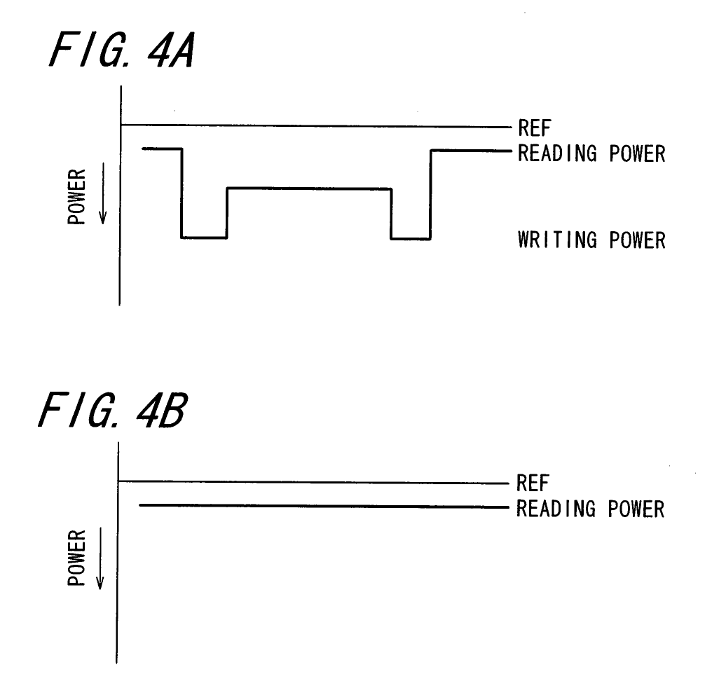

FIGS. 4A and 4B are views illustrating waveforms of conversion voltages emitted from the front monitor apparatus 6. FIG. 4A shows a waveform of a conversion voltage at the time of recording on the optical recording medium 7, and FIG. 4B shows a waveform of a conversion voltage at the time of reproduction on the optical recording medium 7.

As shown in FIGS. 4A and 4B, a gain of the front monitor apparatus 6 is capable of being set to be small by the embodiment, and therefore a hyper-response that reacts greatly to an oscillation of a signal and external influences does not occur, resulting that occurrence of the ringing in the output signal of the front monitor apparatus 6 may be suppressed. Conventionally, the ringing has occurred in a waveform of a conversion voltage outputted from a front monitor apparatus, and a semiconductor laser element driving apparatus has performed a wrong control for the semiconductor laser element, and therefore recording performance and reproduction performance have been deteriorated, however, it is possible to improve the deterioration by the front monitor apparatus 6.

Further, a frequency band of the front monitor apparatus 6, that is, a range of a frequency of a pulse light capable of corresponding to the first photodiode PD1 and the second photodiode PD2 of the front monitor apparatus 6 does not become narrow, resulting that good follow-up performance may be obtained even when the output of the semiconductor laser element 2 changes significantly and the high speed response may be enhanced. Specifically, the frequency band of a front monitor apparatus with one photodiode PD1 is in the range of 50 MHz to 80 MHz, while the frequency band is capable of being set in the range of 60 MHz to 120 MHz in the embodiment.

Accordingly, a rise of the waveform is rapid and therefore the high speed response is improved. Thus, the front monitor apparatus is capable of monitoring accurately the laser beam emitted from the semiconductor laser element 2, and an output control for the laser beam of the semiconductor laser element 2 at the time of reproduction and a write strategy control are capable of being performed accurately. Conventionally, at the time of high output of the semiconductor laser, it has been impossible that a front monitor apparatus monitors a waveform of a recording strategy accurately, causing deteriorations of recording performance and a jitter, however, these points can be improved. In addition, it is possible to improve the deterioration of reproduction performance at the time of low output of the laser beam of the semiconductor laser element since the intensity of the laser beam of the semiconductor laser element can not be monitored, and it is also possible to solve a problem that a tracking servo has been deviated from a information track and therefore reproduction could not be performed.

Further, in the embodiment, a photodiode is further provided in the front monitor apparatus 6, and therefore the laser beam emitted from the semiconductor laser element 2 is capable of being monitored stably, with respect to an erasure power at the time of erasure.

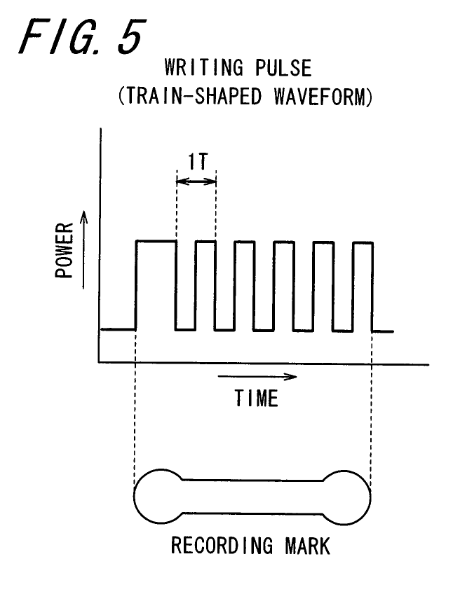

FIG. 5 is a view illustrating a write strategy of a train-shaped waveform and an example of a recording mark formed on the optical recording medium 7 by the write strategy.

In the embodiment, a control of the write strategy is capable of being executed accurately in the train-shaped waveform strategy as well as shown in FIG. 5 in addition to the crown waveform strategy.

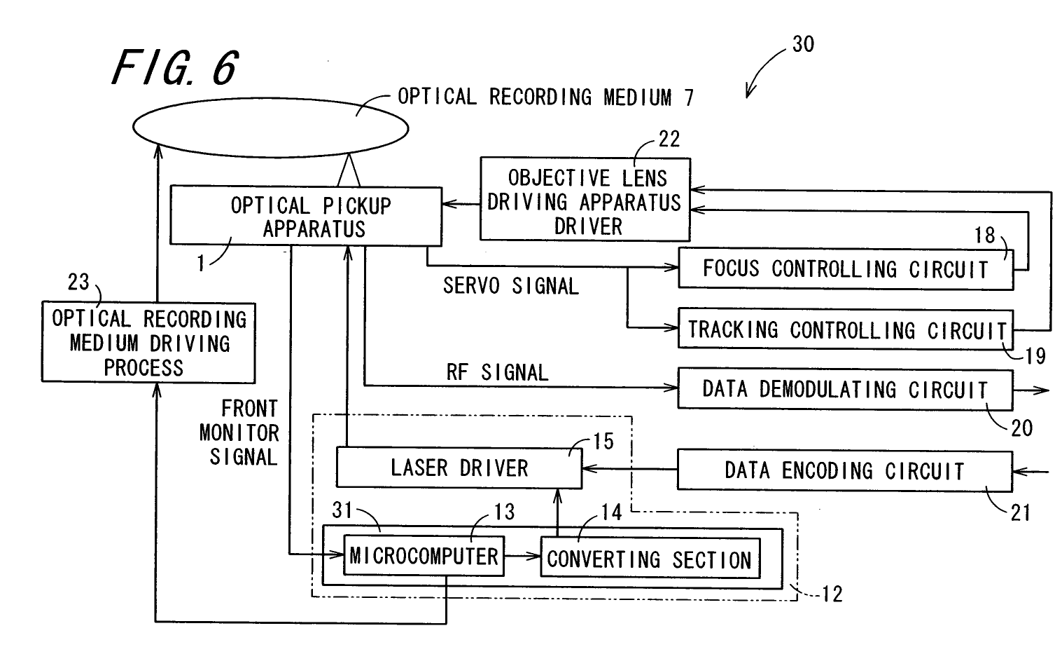

FIG. 6 is a view schematically illustrating a structure of an information recording and reproducing apparatus 30 provided with the optical pickup apparatus 1 according to the invention. In FIG. 6, identical structures as FIG. 1 will be identified with the same reference symbols, and overlapping descriptions will be omitted.

The information recording and reproducing apparatus 30 comprises the optical pickup apparatus 1, the semiconductor laser element driving apparatus 12, and an optical recording driving apparatus 23. The optical pickup apparatus 1 includes an objective lens driving apparatus and a photodetector that are not shown, in addition to above described structures. The laser driver 15 causes the semiconductor laser element in the optical pickup apparatus 1 to emit light and emit a laser beam. The front monitor apparatus in the optical pickup apparatus 1 detects a light intensity of the laser beam, and a front monitor signal as the detection signal is inputted to the APC circuit 31, then the laser driver 15 is controlled based on the output of the front monitor apparatus so that a power of the laser beam is optimum.

A part of the photodetector output in the optical pickup apparatus 1 is supplied to a focus controlling circuit 18 and a tracking controlling circuit 19 as a servo signal, and a focus servo signal and a tracking servo signal outputted from the focus controlling circuit 18 and the tracking controlling circuit 19 respectively are supplied to an object lens driving apparatus driver 22 to drive the object lens driving apparatus in the optical pickup apparatus 1, and then a focus servo and a tracking servo are carried out.

A demodulating circuit 20 demodulates an RF (Radio Frequency) signal as the photodetector output in the optical pickup apparatus 1 to output. A data encoding circuit 21 encodes recording data to supply to the laser driver 15. The microcomputer 13 controls the whole information recording and reproducing apparatus 30 including the APC circuit.

The information recording and reproducing apparatus 30 provided with the optical pickup apparatus of the embodiment includes a personal computer and a DVD video recorder.

The information recording and reproducing apparatus 30 comprises the optical pickup apparatus 1 described above and optical currents obtained from a plurality of photodiodes of the front monitor apparatus are converted into voltages at different current voltage conversion efficiencies respectively, resulting that the high speed response is enhanced, as well as it is possible to suppress the occurrence of the ringing in a waveform of a conversion voltage outputted from the front monitor apparatus and to monitor stably the laser beam emitted from the semiconductor laser element. In addition, the APC circuit 31, based on the detected electrical signal, determines the output of the laser beam emitted from the light emitting element and drives the laser driver 15 so that the output intensity of the laser beam emitted from the semiconductor laser element is constant, and therefore it is possible to condense a laser beam of a proper intensity on the optical recording medium 7, resulting that recording performance and reproduction performance for the optical recording medium 7 may be improved.

Note that the optical pickup apparatus 1 is applicable to an apparatus that monitors an optical output using a photodiode to control the optical output by the obtained detection result, in addition to the information recording and reproducing apparatus 30.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A front monitor apparatus that monitors a laser beam emitted from a light emitting element provided in an optical pickup apparatus, the front monitor apparatus comprising:
a plurality of light receiving elements each having different light receiving sensitivity, for receiving the laser beam and outputting a current corresponding to a light receiving intensity;
a signal processing circuit for differentiating voltage conversion levels for converting a current to a voltage, in association with the respective light receiving elements so that a voltage to be converted when a predetermined current is supplied from a light receiving element having low light receiving sensitivity exceeds a voltage to be converted when the predetermined current is supplied from a light receiving element having high light receiving sensitivity, and outputting a voltage which is obtained by conversion of a current from the respective light receiving elements.

2. The front monitor apparatus of claim 1, wherein the plurality of light receiving elements and the signal processing circuit are formed into one chip by a semiconductor integrated circuit.

3. An optical pickup apparatus comprising the front monitor apparatus of claim 1.

4. The optical pickup apparatus of claim 3, further comprising a driving section for driving the light emitting elements so that an emission intensity of the laser beam to be emitted is a predetermined one based on the voltage supplied from the signal processing circuit,
wherein the plurality of light receiving elements are the two light receiving elements, and
in the driving section, a light of a higher intensity than the predetermined emission intensity of the light emitting element is detected based on a voltage outputted by supplying a current outputted from one of the light receiving elements to the signal processing circuit, and a light of a lower intensity than the predetermined emission intensity of the light emitting element is detected based on a voltage outputted by supplying a current outputted from the other light receiving element to the signal processing circuit.

5. An information recording and reproducing apparatus comprising the optical pickup apparatus of claim 3.
